(19) United States
(12) Patent Application Publication
(10) Pub. No.: US 2026/0208720 A1
(43) Pub. Date: Jul. 23, 2026

(54) Planar air jet for skirtless air cushion vehicle

(71) Applicant: Celerity Craft, Inc., Squamish (CA)

(72) Inventors: Xavier Bernard, Squamish (CA); Saman Lak, Vancouver (CA)

(21) Appl. No.: 19/032,415

(22) Filed: Jan. 20, 2025

(51) Int. Cl. B60V 3/06

(52) U.S. Cl. CPC B60V 3/065

(57) ABSTRACT

Hinged plates or flexible skirts typically used in seal systems at the bow and stern of traditional air cushion vehicles suffer drag and wave impact. Herein, a planar air jet is used instead, at the bow, stern or both. The planar air jets present less drag to the vehicle. Waves may pass through the planar air jets so that the seal they provide for the air cushion remains intact.

### TECHNICAL FIELD

This application relates to air cushion vehicles. In particular it relates to configurations for maintaining the pressure of the air cushion at the bow and stern.

### BACKGROUND

One type of air cushion vehicle (ACV) or craft has the form of a catamaran, with rigid sides and flexible skirts at the bow and stern. This can be referred to as a surface effect ship (SES). By pressurizing the air underneath, the ACV is raised, resulting in lower drag. In some types of ACV, air cushions provide combined lift and thrust actions.

U.S. Pat. No. 3,342,278 to Cocksedge describes an ACV with three hulls and two air chambers between them. Bow plates are used to open and close the front of the air chambers, allowing waves to pass through. These plates induce aerodynamic drag, as well as hydrodynamic drag when they contact water. Additionally, waves contacting the plates result in slamming vibrations which are felt by ACV occupants.

This background is not intended, nor should be construed, to constitute prior art against the present invention.

### SUMMARY OF INVENTION

The ACV disclosed herein replaces the seal system at the bow and/or stern by an intangible planar jet of air. Blowing a relatively thin layer of fast moving air at the bow and/or stern of the ACV helps to ensure that the pressurized air in the chamber or plenum does not escape, while allowing waves to pass through without interference. Such a system also increases occupant comfort, due to reduced wave slamming at the bow of the ACV. In addition, the bow and stern planar air jets can be used for trim angle adjustments through an active control system.

Disclosed is an ACV for travelling on water, the ACV comprising: a bow; a stern; at least two hulls arranged side by side; a linear nozzle at the bow, positioned to direct a planar air jet downwards and aft between the two hulls, the planar air jet spanning a gap between the two hulls; and a stern seal extending between the two hulls; wherein a plenum for an air cushion is formed by at least the two hulls, the planar air jet, the stern seal, an underside of a deck of the ACV and a surface of the water.

Also disclosed is an air cushion vehicle (ACV) for travelling on water, the ACV comprising: a bow; a stern; at least two hulls arranged side by side; a bow seal extending between the two hulls; a stern seal extending between the two hulls; and one or more nozzles positioned to direct one or more planar air jets between the two hulls, the one or more planar air jets spanning a gap between the two hulls; wherein the one or more nozzles are (a) at the bow and the one or more planar air jets form the bow seal or (b) at the stern and the one or more planar air jets form the stern seal; and wherein a plenum for an air cushion is formed by at least the two hulls, the bow seal, the stern seal, an underside of a deck of the ACV and a surface of the water.

Some embodiments of the ACV are also capable to some degree of amphibious travel, such as over mud or sand. In this case the ACV may be described as light amphibious. In some embodiments the ACV is a trimaran with exactly three hulls arranged side by side and seal system at the bow and stern to define exactly two distinct air cushions.

This summary provides a simplified, non-exhaustive introduction to some aspects of the invention, without delineating the scope of the invention.

### BRIEF DESCRIPTION OF DRAWINGS

The following drawings illustrate embodiments of the invention and should not be construed as restricting the scope of the invention in any way.

FIG. 1 is a top view of an ACV, according to an embodiment of the present invention.

FIG. 2 is a cross-sectional side view of an ACV, according to an embodiment of the present invention.

FIG. 3 is a side view of a planar jet in an ACV, according to an embodiment of the present invention.

FIG. 4 is a cross-sectional side view of an adjustable linear nozzle in an ACV, according to an embodiment of the present invention.

FIG. 5 is a cross-sectional side view of twin linear nozzles in an ACV, according to an embodiment of the present invention.

FIG. 6 is a front view of an ACV with a planar jet below a partial bow plate, according to an embodiment of the present invention.

FIG. 7 is a front view of an ACV with a planar jet between two partial bow plates, according to an embodiment of the present invention.

FIG. 8 is a front view of an ACV with a planar jet combined with a bow grille, according to an embodiment of the present invention.

### DESCRIPTION

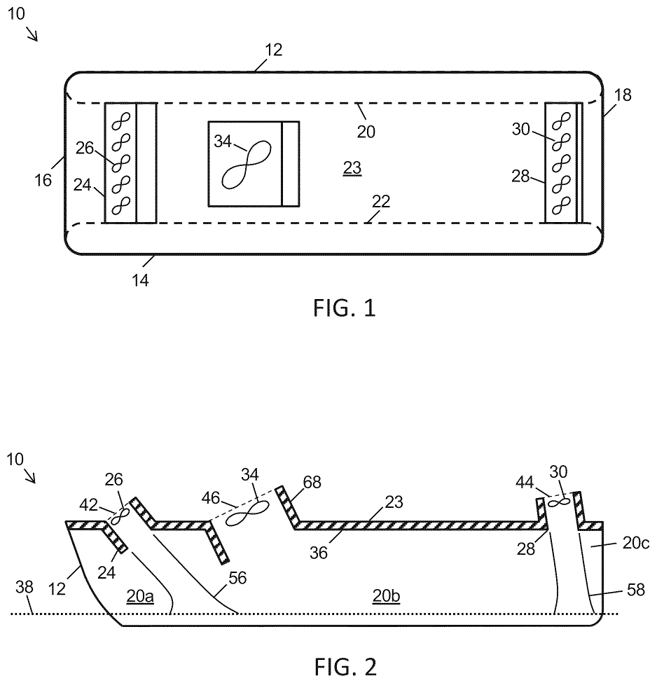

Referring to FIG. 1, the top of an ACV 10 is shown. It has two rigid hulls 12, 14 extending from the bow 16 to the stern 18. The hulls have rigid inner side walls 20, 22. Projecting through the wet deck 23 at the fore there is a linear nozzle 24 or slit with an impeller or a plurality of impellers 26 that operate to provide a planar air jet. Projecting through the deck at the aft there is another linear nozzle 28 or slit with another impeller or plurality of impellers 30, for example in an array, that operates to provide another planar air jet. Also shown is the impeller 34 for pressurizing the air cushion below the ACV, providing a lift force to the ACV.

Note that in other embodiments the air for the planar air jet may be provided by other configurations of impellers. For example, one or both of the planar air jets may be provided by the main fan system for the lift and/or thrust. In this case the impeller would be referred to as a fan or air pump, which acts both as an impeller and propeller. In other examples, one or both of the planar air jets may be provided by a bypass or bleed air system that recoups energized (i.e. pressurized or moving) air found in and/or around the ACV.

Referring to FIG. 2, a cross-sectional side view of the ACV 10 is shown. The impellers 26, 30, 34 are protected by grilles 42, 44, 46 respectively. The nozzles 24, 28 for the fore and aft planar jets are both angled downwards and to the aft, producing planar jets 56, 58 respectively. The planar air jet 58 at the stern is pointing closer to vertical than the fore planar air jet, and in some embodiments, it is pointed inwards towards the air cushion. As described below, the angles of the planar air jets are adjustable in some embodiments, with one or both of the fore and aft planar air jets being directed towards the fore. The inner wall 20 of the starboard hull 12 can be considered to be divided into regions. A first region 20a is fore of the planar jet 56. A second region 20b is between the two planar jets 56, 58. A third region is aft of the planar jet 58.

The air cushion has a starboard extent defined by the second region 20b of the hull 12 and a port extent defined by the corresponding region of the inner side wall 22 of the hull 14. The top of the air cushion is defined by the underside 36 of the wet deck 23. The bottom of the air cushion is defined by the surface 38 of the water. At low speed, the ACV moves in displacement mode, in which the hulls are in the water and the cushion pressure is kept low. As the pressure of the air cushion ACV increases, the hulls rise until they are largely above the water, allowing for reduced drag and higher speed. The front and rear of the air cushion are defined by the planar jets 56, 58 respectively which provide an effective barrier for air, but allow waves to pass through. In other words, a plenum for the air cushion is formed by the hulls, the planar air jets, the underside of the wet deck and the surface of the water.

In some embodiments, only one of the planar air jets 56, 58 is present, and a traditional seal system such as a bow plate or stern plate replaces the other. The bow and stern plates may be referred to as a type of bow seal and stern seal respectively. The planar air jets may also be referred to as a type of bow seal and stern seal.

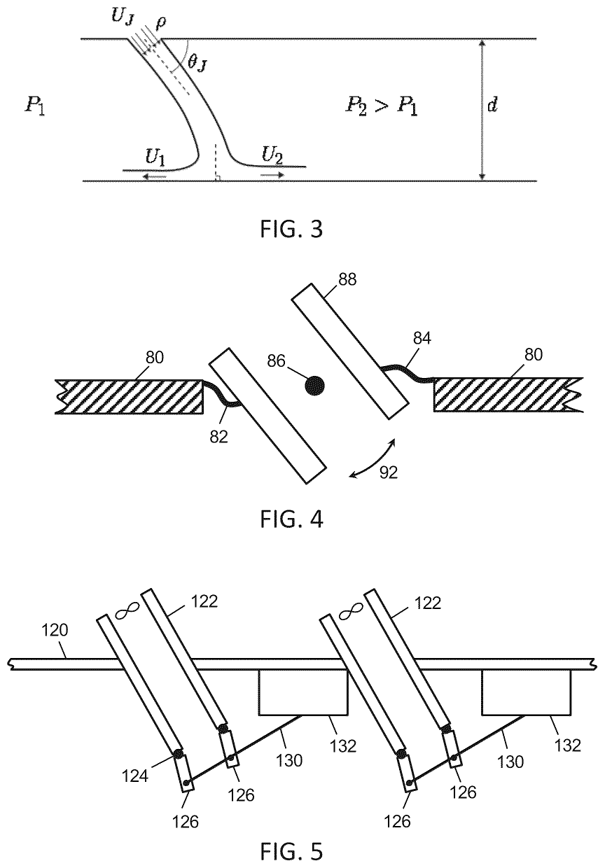

Referring to FIG. 3, the difference in pressure across a fore planar air jet is shown. To the left of the figure, forward of the fore planar air jet, the pressure is P₁ and corresponds to the ambient air pressure. Behind the fore planar air jet the pressure is P₂, which is higher than P₁ and corresponds to the pressure of the air cushion. When considering the aft planar air jet, the pressure in front of it would be higher than the pressure behind it. The objective is to maintain the pressure difference between the air cushion and the ambient atmosphere, i.e. to maintain P₂ above P₁ with a specific pressure difference ΔP.

As shown, the planar air jet has a jet velocity U_{J} at an angle θ_{J}. The planar air jet splits at the surface of the water into a portion moving forward with a speed U₁ and a portion moving backwards with a speed U₂. The higher pressure P₂ on the right side of the planar air jet bends the jet towards the lower pressure region on the left. If the pressure is too high so as to bend the planar air jet completely, the planar air jet is less effective or not effective. Therefore, the maximum pressure the planar air jet can manage causes the jet to bend in a manner that leads to the perpendicular impingement of the jet onto the water surface bounding the air cushion at the bottom. In this case, the momentum equation governing the motion of the jet in the horizontal direction yields:

$$( {P}_{2} - {P}_{1} ) \cdot d \cdot b = ρ {U}_{J}^{2} \cdot sin {θ}_{J} cos {θ}_{J} \cdot b \cdot t$$

where d, b, and t denote the air cushion height, air cushion width (which equals the planar air jet width), and the thickness of the slit (planar air jet nozzle) respectively. The density of the air in the planar air jet is ρ. Based on this equation, the maximum pressure difference a planar air jet with the given parameters can provide is:

$$Δ {P}_{max} = \frac{ρ {U}_{J}^{2} \cdot sin 2 {θ}_{J} \cdot t}{2 d}$$

Therefore, and as a guideline, the maximum pressure difference that the planar air jet can retain increases with the planar jet velocity, and thickness. The maximum pressure difference that the planar air jet can retain also increases as the angle of the planar jet approaches 45° from either the horizontal or vertical. In contrast, increasing the air cushion height reduces the achievable pressure difference.

These calculations assume that the vehicle is stationary. When the vehicle is in forward motion, the pressure P₁ in front of the vehicle increases. Approximately, this increase in the lower pressure P₁ is equal to the dynamic pressure of the airflow

$$\frac{1}{2} ρ {U}_{v}^{2} ,$$

where Uᵥ is the vessel speed. Therefore, the maximum velocity and thickness of the air jet can be determined based on stationary conditions. As the major effects of air temperature and humidity are on the density of air, and since these variations are usually not significant due to the limited operating temperature range of the vehicle, such changes are usually not of concern with regard to the performance of the air cushion.

Another factor to take into account when configuring the parameters of the planar air jets is the full height variation of the waves over which the ACV is to travel. The encounter of the ACV with large waves causes a significant variation in the gap size at the front of the ACV, between the wet deck and the surface of the water. The variation of gap height at the front of the ACV over a trough of a wave risks introduces variation in the effectiveness of the planar air jet based on the equations presented above. To control the effectiveness of the seal, it is desirable to adjust the parameters of the planar jet (angle θ_{J}, speed U_{J}, and thickness of the jet), in accordance with the environmental parameters (pressure P₁ and P₂, as well as gap height d). The range of those parameters is informed by the expected sea states that the ACV will be operating in. The maximum speed and thickness of the planar air jet can be calculated based on the maximum front gap by adding at least the wave amplitude to the air cushion height of the ACV when the impeller systems are not powered. As the wave amplitude changes during the trip, the velocity of the planar air jet may be adjusted accordingly. For lower wave amplitudes, the velocity may be lower than for higher wave amplitudes. By adjusting the strength of the planar air jet, overall energy consumption may be reduced compared to using a fixed velocity for the entire trip of the ACV.

Given the target dimensions and mass of the vehicle, the required pressure difference for lifting the ACV, assuming that the only source of lift is the air cushion, would be approximately 2% of the atmospheric pressure. Moreover, due to the equation relating the pressure difference to the jet characteristics, an angle of 45° is optimal for the planar air jet. However, other angles are also possible in other embodiments. Consider an ACV that is 10 m long, 5 m wide, has a 1 m high air cushion, and has a total mass of 10 tons when fully loaded. The required pressure difference in this case can be achieved by a 20 cm wide slit for the planar jet and a jet velocity of about 130 m/s.

Referring to FIG. 4 the nozzle 88 for the planar air jet is adjustable in some embodiments. The nozzle 88 pivots about pivot axis 86 and is sealed to the upper deck 80 with flexible seals 82, 84. By adjusting the angle 92 of the nozzle 88, the angle of the planar air jet can be adjusted. In some embodiments it may be desirable to adjust the angle of the planar air jet based on the weather and water conditions or on the load of the ACV. As noted above, in some embodiments it may also be desirable to adjust the velocity the planar air jet based on the weather and water conditions or on the load of the ACV.

In some embodiments there are two planar air jets arranged close to each other in a pair. FIG. 5 shows two linear nozzles 122 mounted in the upper deck 120 of the ACV. The spacing between the exits of the nozzles is approximately triple the thickness of each planar air jet, although different spacings are possible in other embodiments. The exits of the nozzles are fitted with deflector plates 126 which are adjustable about hinges 124 by a control arm 130 and control mechanism 132 to change the direction of each planar air jet. For example, the total angular range of each nozzle could be up to 20°. In some embodiments there are modes of operation in which the two planar air jets are angled slightly towards each other to form a combined planar air jet. This also allows for some control over the direction of the combined planar air jet.

In other embodiments, there are no deflector plates at the nozzle exits, and the planar air jets have fixed directions. The nozzles may be parallel or in some embodiments they are angled slightly towards each other, by, for example 5-10°. When angled towards each other, the relative strength of the planar air jets is adjustable, which allows the angle of the combined planar air jet to be adjusted.

In other embodiments, a group of three or more closely spaced planar air jets may be employed.

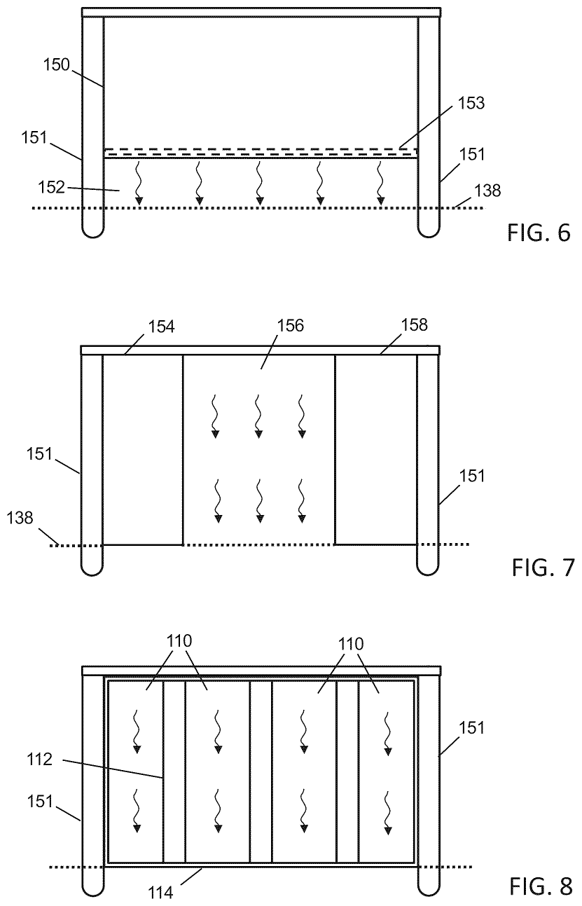

In some embodiments, the planar air jet is arranged as an extender of a traditional bow plate or stern plate. For example, FIG. 6 shows a tangible bow plate 150 which is extended below to the waterline 138 by an intangible planar air jet 152, between the two hulls 151. The ratio of the vertical extent of the tangible bow plate to the intangible bow plate is different in other embodiments. In some cases, this ratio is adjustable by moving the tangible bow plate up or down. The same principle applies to stern plates, which can also be a combination of a traditional, tangible plate and a planar air jet below it. Since the required jet velocity increases with the gap height, it is beneficial to decrease the height that the jet needs to seal. Therefore, the upper part of the sealing, which does not hit the waves, can be a mechanical flap or extendable plate, and the lower part, where the waves are present, can be a planar air jet. The nozzle of the planar air jet 153 may be attached behind the lower edge of the tangible bow plate, or it may be configured to move up and down with it.

In other embodiments as shown in FIG. 7, a traditional, tangible bow plate may project from the inner sides of the hulls 151 in two portions 154, 158, leaving a gap between the two. Each projecting bow plate may be considered to be part of the corresponding hull, or part of a corresponding overall hull structure. A planar air jet 156 is then used to complete the gap between the two tangible side plates of the bow plate, extending down to the water level 138. Again, the ratio of the tangible portion to the intangible portion of the bow plate may be different in different embodiments, and may be adjustable in some embodiments. The same applies to the stern plate.

Referring to FIG. 8, a tangible bow plate is in the form of a grille 114 with solid panels 112 arranged between the hulls 151. The gaps between the panels are completed with a planar air jet 110.

In some embodiments, the planar jet nozzle is not mounted horizontally to the deck 23 of the craft or just below the deck. Instead, two planar jet nozzles are mounted vertically onto the inner side walls of hulls 12 and 14. The planar jets may also be mounted at any angle relative to the horizontal plane.

In some embodiments, planar air jets may be used in place of what would otherwise be a rigid control plate. This could be any rigid plate, fixed or movable, that deflects or controls the flow of air within the air cushion, whether it be air for creating the pressure, air for driving the ACV or air for providing the fore and aft planar jets 56, 58. Additional control surfaces such as spoilers, ailerons and deflectors that are traditionally tangible metal plates could be replaced by planar air jets in some embodiments to further shape and define the airflow within the air cushion. An advantage of this is the reduction of moving mechanical components.

While the nozzles 26, 28 have been shown to be linear, they are curvilinear in some embodiments, or have linear segments angled with respect to each other.

In some embodiments, the hull of the ACV is in the form of a trimaran, in which there are two pressurized air plena side by side. Each plenum has its own independently operated fore and/or aft planar air jets.

Features from any of the embodiments may be combined with features from any of the other embodiments to form another embodiment within the scope of the invention. Some embodiments, depending on their configuration, may exhibit all or fewer than all of the advantages described herein. Other advantages not mentioned may be present in one or more of the embodiments.

All parameters, dimensions, angles, proportions, materials, quantities and configurations described herein are examples only and may be changed depending on the specific embodiment implemented. Numbers, angles and percentages are specified to the nearest significant digit. Numerical values inherently include an expected tolerance, e.g. 10% or to one significant digit, unless specified as exact. All ranges given include all subranges within the range. For example, if a range is given as m-q, then the ranges m-n, n-p and p-q are included, where n and p are any values that satisfy m<n<p<q. In general, unless otherwise indicated, singular elements may be in the plural and vice versa with no loss of generality.

Throughout the description, specific details have been set forth in order to provide a more thorough understanding of embodiments of the invention. However, the invention may be practised without these specific details. In other instances, well known elements have not been shown or described in detail and repetitions of features have been omitted to avoid unnecessarily obscuring the invention. Accordingly, the specification and drawings are to be regarded in an illustrative, rather than a restrictive, sense. It will be clear to one having skill in the art that variations to the details disclosed herein can be made, resulting in other embodiments that are within the scope of the invention disclosed. Accordingly, the scope of the invention is to be construed in accordance with the substance defined by the claims.

1. An air cushion vehicle (ACV) for travelling on water, the ACV comprising:
a bow;
a stern;
at least two hulls arranged side by side;
a bow seal extending between the two hulls;
a stern seal extending between the two hulls; and
one or more nozzles positioned to direct one or more planar air jets between the two hulls, the one or more planar air jets spanning a gap between the two hulls;
wherein the one or more nozzles are:
(a) at the bow and the one or more planar air jets form the bow seal, or
(b) at the stern and the one or more planar air jets form the stern seal;
wherein a plenum for an air cushion is formed by at least the two hulls, the bow seal, the stern seal, an underside of a deck of the ACV and a surface of the water.

2. The ACV of claim 1, wherein each nozzle is adjustable in direction.

3. The ACV of claim 1 further comprising one or more deflector plates positioned to change a direction of the one or more planar air jets.

4. The ACV of claim 1 further comprising:
at least one first impeller that drives air through the one or more nozzles; and
a second impeller that provides the air cushion.

5. The ACV of claim 4, wherein said at least one first impeller has an adjustable speed.

6. The ACV of claim 1, wherein there is exactly one nozzle, mounted horizontally below the deck at the bow and directed downwards and aft at an angle of 45° to the deck.

7. The ACV of claim 1, further comprising a plate extending between the two hulls above the one or more planar air jets.

8. The ACV of claim 7, wherein the plate is adjustable in height.

9. The ACV of claim 1, wherein:
the one or more planar air jets form the bow seal; and
each hull comprises a partial bow plate extending inwards, wherein the gap extends between the two partial bow plates.

10. The ACV of claim 1, further comprising a grille spanning the gap.

11. The ACV of claim 1 further comprising one or more other nozzles at the bow and positioned to direct one or more other planar air jets between the two hulls, the one or more other planar air jets spanning the gap between the two hulls and angled to combine with the one or more planar air jets.

12. The ACV of claim 1 further comprising another nozzle in the plenum positioned to control a flow of air within the air cushion.

13. The ACV of claim 1, wherein:
the one or more planar air jets form the bow seal; and
the stern seal is a plate.

14. The ACV of claim 1, for further travelling on terrain, during which the plenum for the air cushion is formed by at least the two hulls, the bow seal, the stern seal, the underside of the deck of the ACV and a surface of the terrain.

15. The ACV of claim 1, wherein the one or more nozzles are linear.

16. The ACV of claim 1, wherein:
the one or more planar air jets form the bow seal; and
one or more other planar air jets form the stern seal.

17. The ACV of claim 16, wherein:
the one or more planar air jets are directed downwards and aft; and
the one or more other planar air jets are directed downwards and aft.

18. The ACV of claim 17, wherein:
the one or more planar air jets are adjustable to be directed downwards and forwards; and
the one or more other planar air jets are adjustable to be directed downwards and forwards.

19. The ACV of claim 16, having:
exactly three hulls arranged side by side;
one or more further nozzles at the bow for forming one or more further planar air jets at the bow; and
one or more further nozzles at the stern for forming one or more further planar air jets at the stern;
wherein another plenum for another air cushion is formed at a side of the plenum, by at least the one or more further planar air jets at the bow and the one or more further planar air jets at the stern.
